(19) United States
(12) Patent Application Publication
(10) Pub. No.: US 2008/0065481 A1
(43) Pub. Date: Mar. 13, 2008

(54) USER-ASSOCIATED, INTERACTIVE ADVERTISING MONETIZATION

(75) Inventors: Nicole S. Immorlica, Seattle, WA (US); Kamal Jain, Bellevue, WA (US); Jennifer T. Chayes, Seattle, WA (US); Christian H. Borgs, Seattle, WA (US); Mohammad Mahdian, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/531,374

(22) Filed: Sep. 13, 2006

(51) Int. Cl. G06Q 30/00

(52) U.S. Cl. 705/14

(57) ABSTRACT

Dynamically auctioned advertisements are placed in networked platforms based on and associated with a specific user of the platform. The user can then select an advertisement to be associated with them during operation of the platform. Additionally, micro-endorsements or small payments can be made to the user based on their performance within the platform and their selected advertisement. The dynamic advertisement auctions can utilize impressions, selections, and successes to determine how much to charge the advertisers. Payments of the micro-endorsements can emanate from the advertiser charges. As players become more successful, increased micro-endorsements can occur. Additional payments can also be made for user loyalty to a particular advertiser. Demographics of the user can also be employed to determine which advertisements are more likely to appeal to the user and/or are more closely matched to an advertiser's target.

### BACKGROUND

Advertising in general is a key revenue source in just about any commercial market or setting. To reach as many consumers as possible, advertisements are traditionally presented via billboards, television, radio, and print media such as newspapers and magazines. However, with the Internet, advertisers have found a new and perhaps less expensive medium for reaching vast numbers of potential customers across a large and diverse geographic span. Advertisements on the Internet can primarily be seen on web pages or websites as well as in pop-up windows when a particular site is visited. Typically, advertising on the Internet is bought or sold in an auction manner. For example, a search engine can receive a query (from a user) that includes one or more search terms that are of interest to a plurality of buyers. The buyers can place bids with respect to at least one of the search terms, and a buyer that corresponds to the highest bid will have their advertisement displayed upon a resulting page view. Bidding and selection of a bid can occur within a matter of milliseconds, thereby not adversely affecting usability of the search engine.

Advertisers interested in finding new customers and generating revenues continue to look for atypical channels that may be suitable for posting advertisements. The ever increasing popularity of networked platforms such as networked games and online social groups makes them increasingly popular as advertising vehicles. Static placements of advertisements in games, for example, afford some additional opportunities for advertisers to reach gaming audiences in general. However, due to the impersonal nature of the advertisements and the brief exposure times, these types of advertisement placements often do not reach their intended target audiences. Thus, advertisers spend monies on static advertising placements hoping to reach buyers without much likelihood of success.

### SUMMARY

Dynamically auctioned advertisements are placed in networked platforms based on and associated with a specific user of the platform. The user can then select an advertisement to be associated with them during operation of the platform. Additionally, micro-endorsements or small payments can be made to the user based on their performance within the platform and their selected advertisement. The dynamic advertisement auctions can utilize impressions, selections, and successes to determine how much to charge the advertisers. Successes can include, for example, purchase of advertised products, purchase of advertised services, and/or completion of registration for an advertised service/product and the like. Payments of the micro-endorsements can emanate from the advertiser charges. As players become more successful, increased micro-endorsements can occur. Additional payments can also be made for user loyalty to a particular advertiser. Demographics of the user can also be employed to determine which advertisements are more likely to appeal to the user and/or are more closely matched to an advertiser's target. The functions of determining advertisements and/or payment of the micro-endorsements can reside locally and/or remotely to the platform itself. This allows substantial flexibility of implementing the system. The micro-endorsements can encourage successful players to select particular advertisements with high endorsements thereby associating an advertised brand with winning. The micro-endorsements can also, for example, make a game more exciting for a player as there is additional incentive to win and/or increase the effect of the advertising because platform users are more likely to talk within their social networks about how successful they are in obtaining the micro-endorsements and which advertisers are providing the highest payments.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter may be employed, and the subject matter is intended to include all such aspects and their equivalents. Other advantages and novel features of the subject matter may become apparent from the following detailed description when considered in conjunction with the drawings.

### BRIEF DESCRIPTION OF THE DRAWINGS

FIG. 1 is a block diagram of an interactive advertising system in accordance with an aspect of an embodiment.

FIG. 2 is another block diagram of an interactive advertising system in accordance with an aspect of an embodiment.

FIG. 3 is yet another block diagram of an interactive advertising system in accordance with an aspect of an embodiment.

FIG. 4 is an illustration of a networked gaming environment utilizing an instance of an interactive advertising system in accordance with an aspect of an embodiment.

FIG. 5 is a flow diagram of a method of placing interactive advertisements in a networked platform in accordance with an aspect of an embodiment.

FIG. 6 is a flow diagram of a method of rewarding a user based on advertisement selection and platform performance in accordance with an aspect of an embodiment.

FIG. 7 is a flow diagram of a method of charging advertisers for various types of user interactions with their advertisements in a networked platform in accordance with an aspect of an embodiment.

FIG. 8 illustrates an example environment in which an embodiment can function.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It may be evident, however, that subject matter embodiments may be practiced without these specific details. In other instances, well-known structures and devices are shown in block diagram form in order to facilitate describing the embodiments.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers.

Monetization schemes are provided that utilize mechanisms which incorporate users of a networked platform as well as advertisers and the networked platform itself. Instances allow users to be rewarded for the selection of an advertisement conditional on their performance in the platform. These rewards make platform use more fun for the users and increase the value of advertisements for advertisers by giving them a chance to associate their brand name with successful users. Online settings permit micro-payments by advertisers and, thus, allow for sponsorship/endorsement enticements to users of the platform based on performance, increasing market share and revenue of the platform while enhancing the user experience.

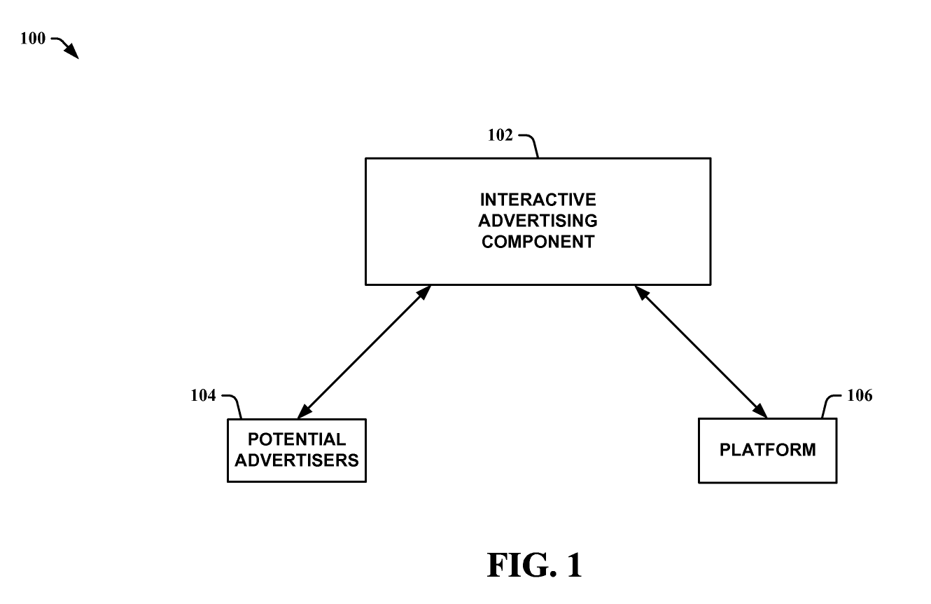

FIG. 1 illustrates an interactive advertising system 100 that utilizes an interactive advertising component 102 to provide advertisements from potential advertisers 104 to a platform 106. The interactive advertising component 102 can monitor the platform 106 to detect when advertising locations and/or objects are available. The interactive advertising component 102 then allows the potential advertisers 104 to dynamically bid on the available advertisement locations/objects in association with a particular user of the platform 106. The platform 106 can include, but is not limited to, networked games, online social networks (including blogs and the like), and/or any other platform that has a measurable means to determine an advantageous quality of users that advertisers value such as a highly skilled player of a game and/or a popular person in social network and the like.

Typically, users with advantageous qualities have greater exposure to other users and/or audiences. For example, people tend to watch highly skilled players in games to cheer them on to win. If the best player utilizes an object in the game with a particular advertiser's advertisement, the advertiser then gains more exposure due to the player's skills (e.g., the player plays longer and thus exposes the advertisement longer, etc.) and/or popularity. In some instances, the interactive advertising component 102 can provide the platform 106 with several advertisements to entice a valuable user. Displaying of the advertisement to a targeted user is called an impression. The interactive advertising component 102 can charge the potential advertisers 104 based on the number of impressions or the number of times the user is exposed to their advertisement. If the user actually selects an advertiser's advertisement, the interactive advertising component 102 can also charge the advertiser for the selection. The interactive advertising component 102 can also track the user's performance and charge an advertiser for the success of the advertisement. Revenue can also take into account the skill of the user.

To motivate users to select their advertisements, advertisers can agree to pay a reward or “micro-endorsement” payment when a certain level of performance is met by the user. The reward can be a monetary reward, a platform associated reward (e.g., extended playing time, etc.), and/or a product discount reward and the like. The payments can also escalate based on each successful performance of an endorsed user. Payments can also incorporate loyalty by tracking the number of times a user selects a particular advertiser and the like and offering increased payments. Users who are successful with a given platform often generate larger audiences and have more friends (i.e., larger social circles). The micro-endorsements by the advertisers can help generate greater exposure both through exposure to larger audiences and also through word-of-mouth advertising initiated by the micro-endorsement payments as users tell others about their winnings.

The interactive advertising component 102 can reside locally and/or remotely to the platform 106. In a remote instance, the interactive advertising component 102 can reside, for example, in an advertisement server that utilizes the Internet to communicate with the platform 106 and/or the potential advertisers 104. In this instance, payments can be made by the potential advertisers 104 to the interactive advertising component 102. The interactive advertising component 102 can then pay incentives to the user based on their performance from the monies collected from the advertisers. Thus, the micro-endorsement payments can be a percentage of the advertising monies charged by the interactive advertising component 102. In a local instance, the interactive advertising component 102 can reside within the platform 106. This can enable the platform 106 to interact directly with the potential advertisers 104. This allows the platform 106 to become a self-contained advertising revenue generating entity.

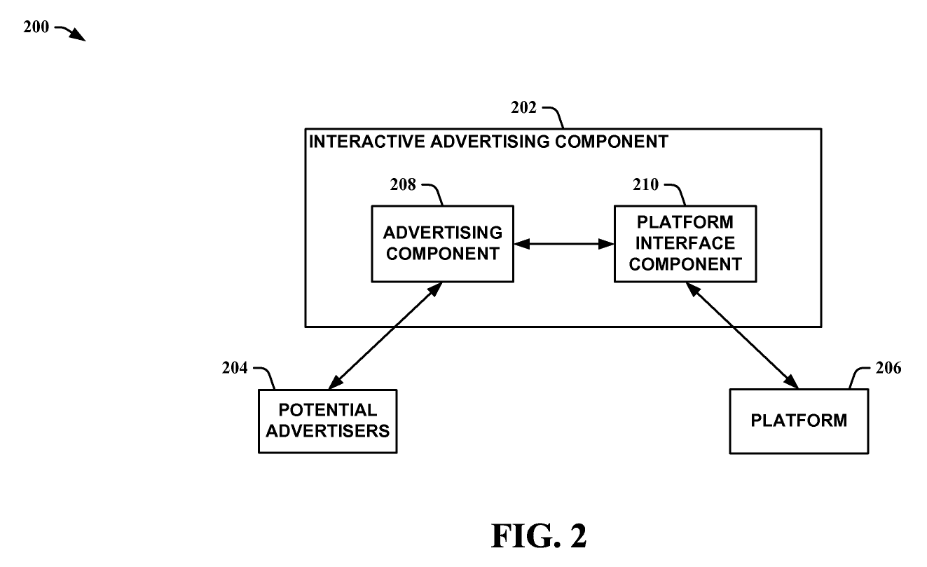

Another example of an interactive advertising system 200 is shown in FIG. 2. The interactive advertising system 200 employs an interactive advertising component 202 that utilizes an advertising component 208 and a platform interface component 210. The advertising component 208 interacts with potential advertisers 204 to provide dynamic auction services for advertising in a platform 206. The advertising component 208 can also charge and/or collect revenues for advertisements from the potential advertisers 204. The advertising component 208 interacts with the platform interface component 210 to place advertisements in the platform 206 and to obtain user information from the platform 206. The user information can contain, for example, a user's performance data, demographics, and/or advertising selections and the like. This information can be used by the advertising component 208 and/or the potential advertisers 204 to find appropriate advertisements for the user based on skill levels and/or demographics and the like.

The platform interface component 210 provides an interface service to allow the advertising component 208 to interact with the platform 206. In some instances, the advertising component 208 can interface with potential advertisers 204 for a variety of platforms. The platform interface component 210 can be duplicated or altered to perform with a given platform, allowing the advertising component 208 to provide services to many different platforms. In yet other instances, the functions of the platform interface component 210 can reside within and/or in proximity of the platform 206. This allows the advertising component 208 to reside externally and interact directly with the platform 206 containing the platform interface component 210, substantially increasing the flexibility of the interactive advertising system 200.

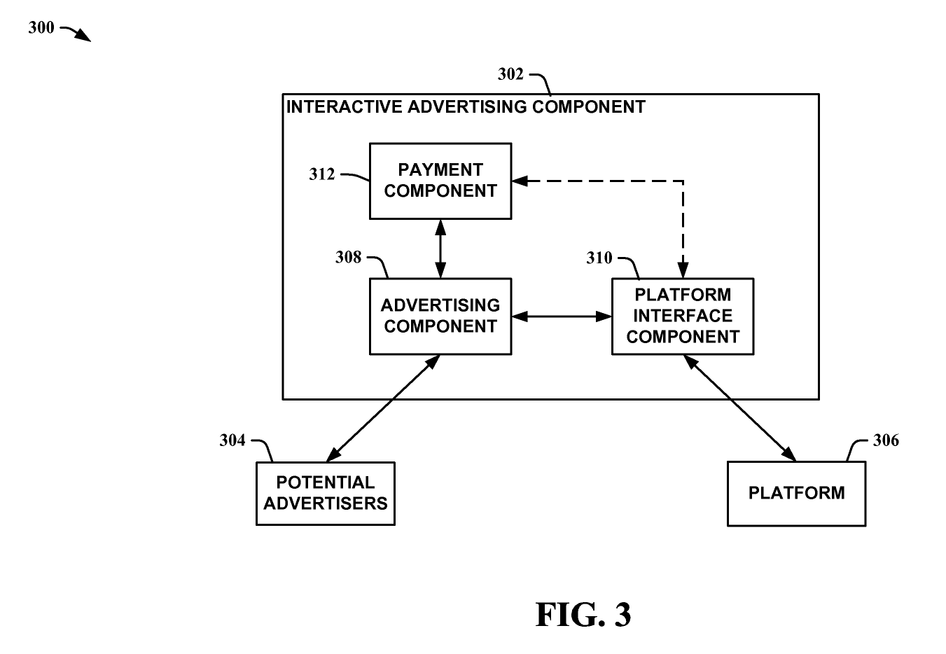

Another instance of an interactive advertising system 300 is illustrated in FIG. 3. The interactive advertising system 300 employs an interactive advertising component 302 that interacts with potential advertisers 304 and a platform 306 to place interactive advertisements. An advertising component 308 interacts with the potential advertisers 304 to provide a dynamic auction for advertisements for the platform 306. The platform interface component 310 interacts with the platform 306 to obtain available advertising locations/objects and/or user information such as skill level, demographics, and advertisement selections and the like. The platform interface component 310 then interacts with the advertising component 308 to facilitate placement of advertisements in the platform 306. In this instance, a payment component 312 is employed to track micro-endorsement payments to users of the platform 306. The payment component 312 can interact with the advertising component 308 and/or optionally directly with the platform interface component 310.

The payment component 312 can utilize various monetization schemes to determine micro-endorsement payments owed to the user of the platform 306. Parameters required for this can include, but are not limited to, demographics of the user, success of the user, which advertiser the user has selected for endorsement payments, loyalty (e.g., prior relationships with a particular advertiser), and/or potential skill of the user and the like. The payment component 312 can also base payments, for example, on the total percentage allotted to micro-endorsements based on revenues collected from the advertiser and the like. Depending on the sophistication of the payment algorithms, some of the functionality of the payment component 312 can reside within the advertising component 308. Separation of the payment component 312 can allow it to be updated frequently as pricing schemes change while not disturbing the auction capabilities of the advertising component 308. It also allows the payment component 312 to reside at a location remote from the interactive advertising component 302.

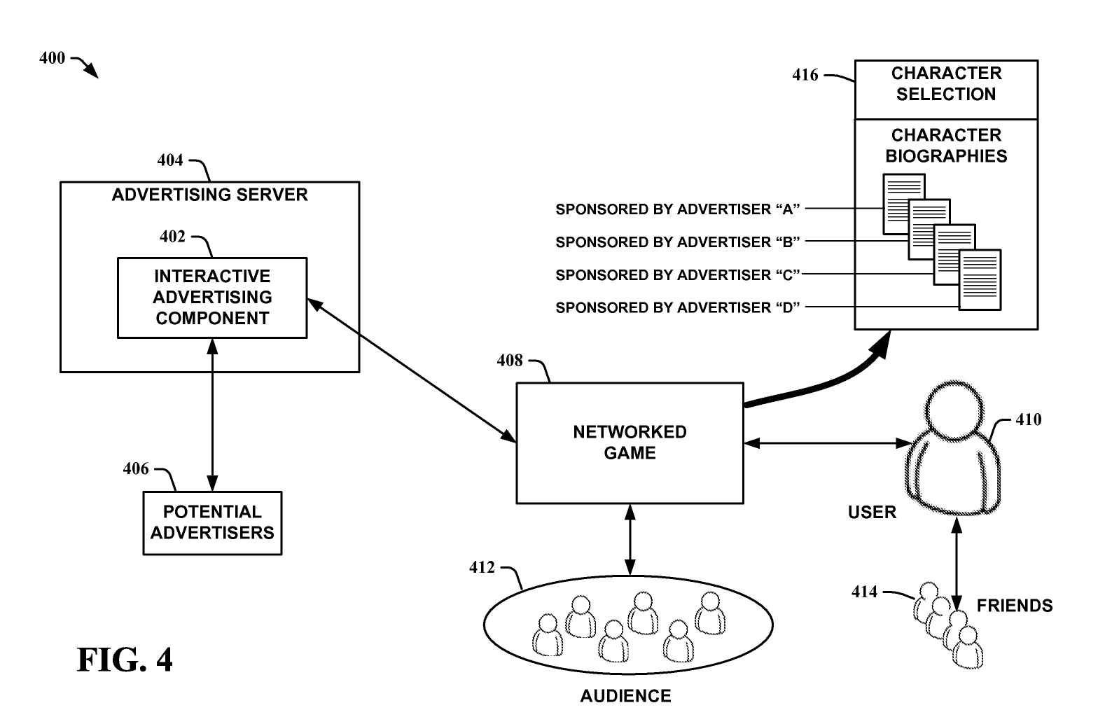

As an example implementation, FIG. 4 illustrates a networked gaming environment utilizing an instance of an interactive advertising system 400 in accordance with an aspect of an embodiment. In this example, an interactive advertising component 402 is utilized inside an advertising server 404. The interactive advertising component 402 interacts with potential advertisers 406 and a networked game 408 (i.e., platform) to place advertisements in the networked game 408. The networked game 408 passes advertising placement information and/or information about a user 410 to the interactive advertising component 402 in the advertising server 404 via a communication means such as, for example, the Internet and the like.

The interactive advertising component 402 alerts potential advertisers 406 to the availability of an advertising location within the networked game 408 and also performance information regarding the user 410. The potential advertisers 406 can assess whether or not to bid on placing their advertisements in association with this particular user 410. The potential advertisers 406 can make their choices based on the user's past loyalty, the user's potential skills in the networked game 408 and/or the likelihood that this particular user 410 might select their advertisement and the like. For example, if the user 410 is female, it is unlikely that this user 410 would select an advertisement for male clothing and the like. Interested potential advertisers 406 then bid on the advertisement placement in association with the user 410.

In this example, the networked game 408 contains fictional characters from which the user 410 can select a character of their choice. This character selection 416 is presented to the user 410, for example, at the beginning of the networked game 408. For this example, each character wears a t-shirt with advertising from different advertisers. The user 410 selects a character from the character selection 416 presented to them by the networked game 408. As a further incentive to entice the user 410 to select their character and advertisement, the advertisers can optionally post an amount of micro-endorsement pay with their advertisements. Larger rewards for performance can draw the attention of the user 410 and influence their selection.

The interactive advertising component 402 tracks both the display of the advertisement to the user 410 (i.e., impressions) and which advertisement/character is chosen (i.e., selections). The networked game 408 typically has an ability to expose game play to an audience 412. The user 410 can be motivated to perform in order to look good in front of this audience 412. The micro-endorsements by the advertisers can also influence the user 410 to perform well, motivated by the micro-endorsement reward. The motivation provided by the micro-endorsement also helps the advertiser to get more exposure when they can associate their advertisement with successful players. These types of players typically draw larger audiences. But, the advertising exposure does not necessarily end with just this type of exposure.

The user 410 who successfully performs and receives micro-endorsement rewards is likely to talk to their friends 414 online and/or offline about how lucrative certain advertiser endorsements can be. This can lead to the advertiser becoming a popular choice among better users, increasing the likelihood of exposure for that particular advertiser. It can be appreciated that the networked game 408 is merely representative of a platform that can utilize instances disclosed herein. Any schema where a user's performance can be ascertained and advertisements can be exposed can utilize these instances. This includes, but is not limited to, online social networks where a user can be determined to be popular based on the number of friends in their social circle and the like.

The actual dynamic auction mechanism can be based on several different types of implementations. In one implementation, each advertiser i submits two bids to the auction: an impression bid bᵢ¹, and a selection bid bᵢ². The advertiser also has the option to offer a reward to a user. This may be in the form of micropayments, coupons, and/or other type of perk and the like. The auction mechanism then estimates pᵢ, the probability that the player selects the advertiser with the given reward. Note that pᵢ is a function of the reward, and so the advertisers can exert some control over this variable. Advertisers are then assigned a rank score Rᵢ equal to bᵢ¹+pᵢ*bᵢ², i.e., the expected bid per impression.

Advertising slots are then assigned to advertisers in a priority ordering defined by decreasing rank score. A payment scheme is then enacted such that the expected payment of advertiser i in slot k is equal to the rank score of advertiser j in slot k+1. One such payment scheme charges advertiser I, (Rⱼ/Rᵢ)*bᵢ¹ for an impression, and (Rⱼ/Rᵢ)*bᵢ² when they are selected. All payments are transferred to the platform. Upon a win, the user additionally receives the designated reward from the advertiser.

Although the above implementation has the virtue of simplicity, from a game-theoretic perspective, it can also be desirable to directly consider the side-payments in the auction itself in order to allocate the advertisement space to the advertisers who value it the most. In such a system, each advertiser i now submits three bids to the auction: an impression bid bᵢ¹, a selection bid bᵢ², and a success bid bᵢ³. The success bid represents the value to an advertiser of having his product associated with a successful platform user, and can be a function of the skill rating of the user involved. The auction computes an expected bid per impression for each advertiser by estimating the selection probability pᵢ and the success probability qᵢ that the user is successful given that they selected i. The rank score (expected bid per impression) is then Rᵢ=bᵢ¹+pᵢ*bᵢ²+pᵢ*qᵢ*bᵢ³. Advertising space is allocated according to this ranking.

Advertisers are then charged according to a payment rule which satisfies the property described above, the expected payment of advertiser i in slot k is equal to the rank score of advertiser j in slot k+1. Again, one such payment scheme charges advertiser i, (Rⱼ/Rᵢ)*bᵢ¹ for an impression, (Rⱼ/Rᵢ)*bᵢ² when they are selected, and (Rⱼ/Rᵢ)*bᵢ³ when the user is successful. If the user is not successful, the platform retains all the advertiser payments. However, when the user succeeds, the platform and the user share the revenue obtained from the selected advertiser i. Any division of the revenue is feasible. However, divisions which give the user at most maxᵢ[(Rⱼ/Rᵢ)*pᵢ*qᵢ*bᵢ³] and the platform at most maxᵢ [(Rⱼ/Rᵢ)*bᵢ¹+(Rⱼ/Rᵢ)*pᵢ*bᵢ²] are game-theoretically more stable.

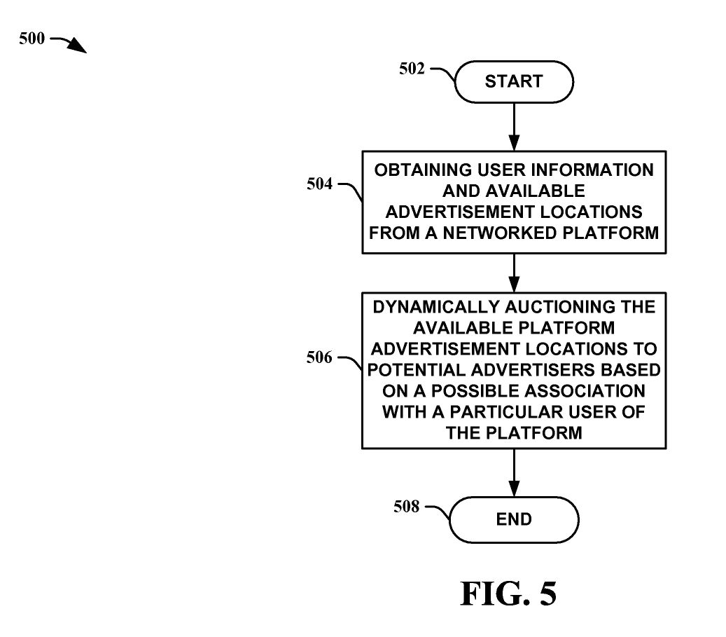

In view of the exemplary systems shown and described above, methodologies that may be implemented in accordance with the embodiments will be better appreciated with reference to the flow charts of FIGS. 5-7. While, for purposes of simplicity of explanation, the methodologies are shown and described as a series of blocks, it is to be understood and appreciated that the embodiments are not limited by the order of the blocks, as some blocks may, in accordance with an embodiment, occur in different orders and/or concurrently with other blocks from that shown and described herein. Moreover, not all illustrated blocks may be required to implement the methodologies in accordance with the embodiments.

The embodiments may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the embodiments.

In FIG. 5, a flow diagram of a method 500 of placing interactive advertisements in a networked platform in accordance with an aspect of an embodiment is shown. The method 500 starts 502 by obtaining user information and available advertisement locations from a networked platform 504. The user information can contain, for example, user demographics, user performance levels with a given platform, and/or user advertising selections and the like. The available platform advertisement locations are then dynamically auctioned to potential advertisers based on a possible association with a particular user of the platform 506, ending the flow 508. Advertisers generally select particular users who are more skilled at a given platform. They also like to associate with users who are likely to be in their advertising target audience. Past selections of the same advertiser's advertisements can also be a factor when an advertiser bids for advertisement association with a particular user. Either of the implementations described supra can be utilized for the advertisement auction along with other variations that include the association with a particular user of a given platform. In most instances, the users can select which advertisement they want to be associated with. Thus, most auctions are conducted such that the advertisers are bidding on a possible association with a user. If that user has previously selected a particular advertiser, the likelihood of being selected by that user can increase specifically for that advertiser, and they can bid accordingly.

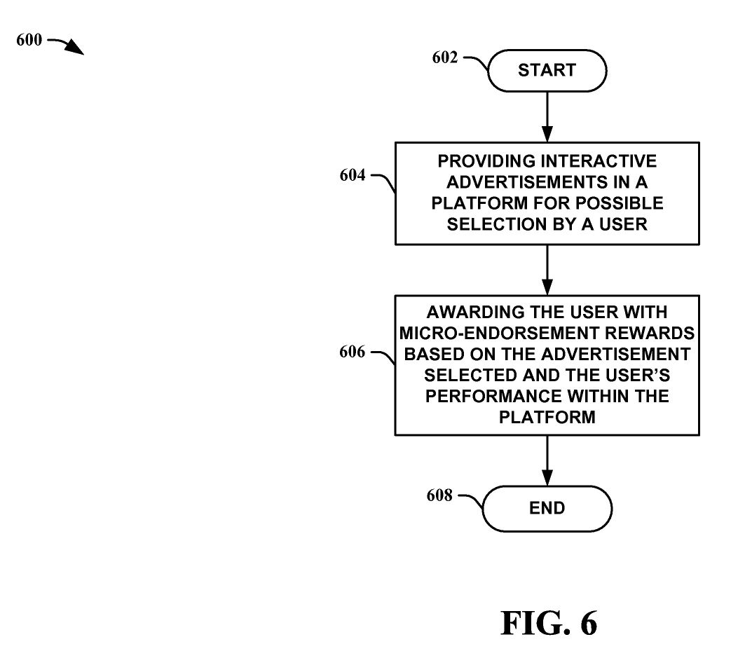

Turning to FIG. 6, a flow diagram of a method 600 of rewarding a user based on advertisement selection and platform performance in accordance with an aspect of an embodiment is depicted. The method 600 starts 602 by providing interactive advertisements in a platform for possible selection by a user 604. The provision of advertisements can be accomplished utilizing techniques described supra. The user is then awarded micro-endorsement rewards based on the advertisement selected and the user's performance within the platform 606, ending the flow 608. The micro-endorsement rewards are incentives to the user to select a particular advertisement and, thus, advertiser. Notifications of the micro-endorsement reward amounts can be included in the advertisements and/or in proximity of the advertisements to entice skilled users to select a particular advertisement.

Advertisers like to be associated with successful players and can increase their micro-endorsement rewards for continuously successful users and/or loyal users. The more often that particular advertisers are selected, the more exposure their products and/or services receive with their target audience. The micro-endorsement rewards themselves can be monetary and/or non-monetary. For example, in lieu of monies, an advertiser can utilize a mechanism to extend game play in a networked game and/or provide free passes to an entertainment invent based on the user's success on a given platform (e.g., tickets to a concert to increase their popularity in an online social network, etc.). The micro-endorsements serve to enlarge exposure of the advertisement to target audiences and also to increase advertisement exposure through word-of-mouth by the user to their friends, fans, and/or family.

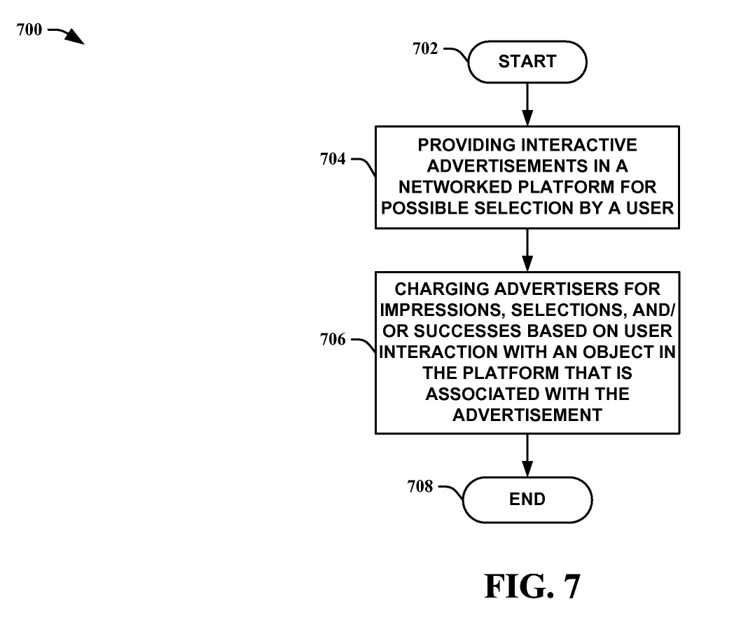

Looking at FIG. 7, a flow diagram of a method 700 of charging advertisers for various types of user interactions with their advertisements in a networked platform in accordance with an aspect of an embodiment is illustrated. The method 700 starts 702 by providing interactive advertisements in a networked platform for possible selection by a user 704. The provision of advertisements can be accomplished utilizing techniques described supra. Advertisers are then charged for impressions, selections, and/or successes based on user interaction with an object in the platform that is associated with the advertisement 706, ending the flow 708. The interactive advertisements can be placed directly into and/or onto an object in the platform.

For example, if the platform is a networked game, weapons used in the game can have different advertising on them. The user of the game can then select which weapon to use in the game and at the same time they are selecting a particular advertiser for endorsements. Thus, the advertisement placement can be seamless to the platform. As an example, when the weapons are displayed to the user, that is an occurrence of an impression or showing of the advertiser to a desired user that the advertisers want to be associated with. When the user selects a particular weapon that is a selection of the advertisement. And when the user succeeds in some fashion (e.g. beating other players, winning the game, or some other performance measure, etc.) that is a success. Advertisers can then be charged for these measures based upon bids submitted for each type of measure. Some schemes utilize the second highest bidder values instead of the winning advertiser's bids and the like. Two dynamic auction implementations have been described supra, but other variations can be employed as well to determine revenue from various measures.

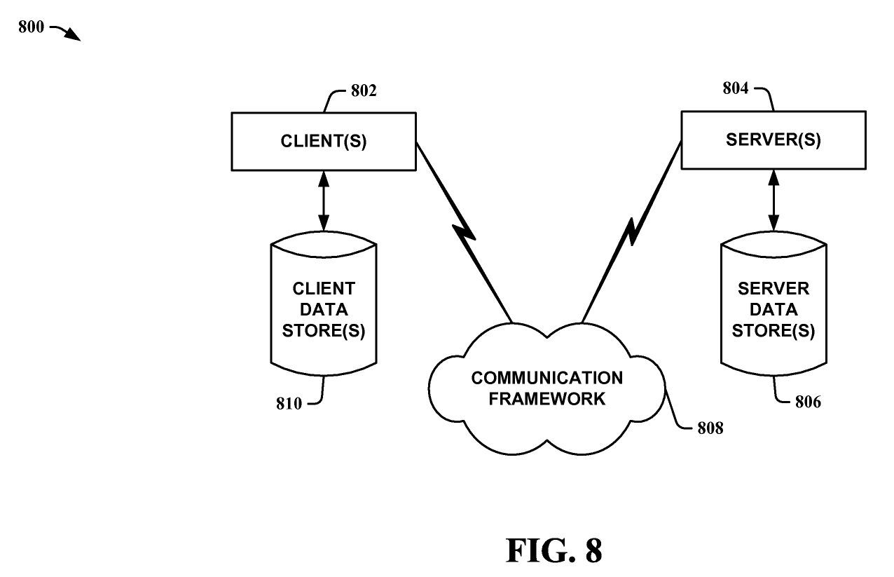

FIG. 8 is a block diagram of a sample networked environment 800 with which embodiments can interact. The environment 800 further illustrates a system that includes one or more client(s) 802. The client(s) 802 can be hardware and/or software (e.g., threads, processes, computing devices). The environment 800 also includes one or more server(s) 804. The server(s) 804 can also be hardware and/or software (e.g., threads, processes, computing devices). One possible communication between a client 802 and a server 804 can be in the form of a data packet adapted to be transmitted between two or more computer processes. The environment 800 includes a communication framework 808 that can be employed to facilitate communications between the client(s) 802 and the server(s) 804. The client(s) 802 are connected to one or more client data store(s) 810 that can be employed to store information local to the client(s) 802. Similarly, the server(s) 804 are connected to one or more server data store(s) 806 that can be employed to store information local to the server(s) 804.

It is to be appreciated that the systems and/or methods of the embodiments can be utilized in advertising placement facilitating computer components and non-computer related components alike. Further, those skilled in the art will recognize that the systems and/or methods of the embodiments are employable in a vast array of electronic related technologies, including, but not limited to, computers, servers and/or handheld electronic devices, and the like.

What has been described above includes examples of the embodiments. It is, of course, not possible to describe every conceivable combination of components or methodologies for purposes of describing the embodiments, but one of ordinary skill in the art may recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for placing advertisements in a platform, comprising:
obtaining user information and available advertisement locations from a networked platform; and
dynamically auctioning the available platform advertisement locations to potential advertisers based on a possible association with a particular user of the platform.

2. The method of claim 1 further comprising:
allowing the user to select the user's advertiser association via selection of an advertisement within the platform.

3. The method of claim 2 further comprising:
providing a micro-endorsement reward to the user based on the user's selected advertiser and the user's performance within the platform.

4. The method of claim 3 further comprising:
utilizing a monetary reward, a platform associated reward, and/or a product discount reward as the micro-endorsement reward.

5. The method of claim 3 further comprising:
extracting the micro-endorsement reward from an advertiser's advertisement fees.

6. The method of claim 2 further comprising:
notifying the user of potential micro-endorsement rewards to entice selection of a particular advertiser.

7. The method of claim 2 further comprising:
selecting the advertiser association by selecting objects with an advertisement within the platform.

8. The method of claim 1 further comprising:
charging advertisers for impressions, selections, and/or successes based on per impression bids, per selection bids, and/or per success bids.

9. The method of claim 1 further comprising:
selecting advertisers for a platform based on their advertisement target and the demographics of the platform user.

10. The method of claim 1 further comprising:
utilizing a networked game and/or a social network as the platform.

11. The method of claim 10 further comprising:
utilizing popularity as a measure of performance for determining a user advertisement association in a social network.

12. A system that facilitates advertising placement, comprising:
a platform interface component that interacts with a networked platform to obtain user information and available advertisement placements and to place advertisements in the platform; and
an advertising component that utilizes, at least in part, an auction-based mechanism to dynamically provide advertisements in the platform in association with a user by interacting with advertisers and the platform interface component.

13. The system of claim 12 further comprising:
a payment component that determines endorsement payments to the user based on a user selected advertisement and a user's performance within the platform as determined from the user information.

14. The system of claim 13, the user's performance based on a number of wins in a game, a user's skill level in a game, and/or a user's popularity in a social environment.

15. The system of claim 13, the payment component increases the endorsement payment to the user based on the user's continued performance within the platform and/or the user's loyalty based on advertisement selections.

16. The system of claim 12, the platform comprising a network game and/or a social network.

17. The system of claim 12 resides locally and/or remotely to the platform.

18. A system that facilitates advertising placement within networked platforms, comprising:
means for obtaining a user's demographics and their platform performance information;
means for determining available advertisement locations in the platform;
means for associating dynamically auctioned advertisements for the platform with a particular user; and
means for providing micro-endorsements to the user based on the user's advertisement selection and the user's performance within the platform.

19. A computer readable medium having stored thereon computer executable components of the system of claim 12.

20. A device employing the method of claim 1 comprising at least one selected from the group consisting of a computer, a server, and a handheld electronic device.
